(19) United States
(12) Patent Application Publication
(10) Pub. No.: US 2026/0185603 A1
(43) Pub. Date: Jul. 2, 2026

(54) METHOD FOR DETERMINING AT LEAST ONE VOLUME FLOW RATE IN AN APPARATUS FOR A HYDRAULIC SYSTEM, COMPUTER PROGRAM PRODUCT, AND COMPUTER DEVICE

(71) Applicant: AUDI Aktiengesellschaft, Ingolstadt (DE)

(72) Inventors: Michael JONUSCHEIT, Nürnberg (DE); Jochen PSCHERWOK, Eichstätt (DE); Stefan AMMLER, Bergheim (DE); Dietmar SCHULLER, Altmannstein (DE)

(73) Assignee: AUDI Aktiengesellschaft, Ingolstadt (DE)

(21) Appl. No.: 19/131,134

(22) PCT Filed: Nov. 23, 2023
(86) PCT No.: PCT/EP2023/082792

§ 371 Date: May 19, 2025

(30) Foreign Application Priority Data
Nov. 29, 2022 (DE) 10 2022 131 629.7

(51) Int. Cl. F16H 57/04

(52) U.S. Cl. CPC F16H 57/0435; F16H 57/0412; F16H 57/0441; F16H 57/0473

(57) ABSTRACT

A method for determining at least one volume flow rate in an apparatus for a hydraulic system, including the steps of: determining a temperature of the medium in the reservoir, determining a total volume flow rate conveyed by the hydraulic pressure source in the first hydraulic line depending on the temperature, determining a first partial volume flow rate discharged into the reservoir through the pressure-limiting valve, and determining a second partial volume flow rate through the aperture and the throttle to the device as a difference between the total volume flow rate and the first partial volume flow rate.

### FIELD

The invention relates to a method for determining at least one volume flow rate in an apparatus for a hydraulic system. The invention also relates to a computer program product and a computer device for performing the method.

### BACKGROUND

Hydraulic systems for drive modules in motor vehicles are known from the prior art, which have hydraulic circuits for cooling and/or lubricating clutches and drive machines. In particular, drive modules for hybrid vehicles are known which comprise an internal combustion engine and an electric machine for selectively driving the motor vehicle. Such drive modules usually comprise clutches for disconnecting and connecting the electric machine the internal combustion engine with a drive train of the motor vehicle. Cooling and lubricating oil, which circulates in cooling circuits, is required to cool and lubricate the clutches and the electric machine itself. The drive module usually comprises separate cooling circuits for the clutches, wherein at least the clutch assigned to the electric machine and the clutch or clutches assigned to the internal combustion engine are each assigned a pump, usually driven by an electric motor, for adjusting a cooling medium flow. The at least two pumps are usually controlled by a control device, wherein the cooling medium flow is adjusted in particular depending on the rotational speed of the pumps.

### SUMMARY

The invention is based on the task of providing a method for determining at least one volume flow rate in an apparatus for an improved hydraulic system, which comprises reduced complexity.

An apparatus is provided with a first hydraulic line which is connectable to a hydraulic pressure source, in particular comprising at least one pump, for conveying a liquid medium on the one hand and to at least one device to be cooled and/or lubricated on the other hand, wherein the first hydraulic line is assigned a pressure-limiting valve which comprises a tank connection to a reservoir for the liquid medium and connects the first hydraulic line to the tank connection when a hydraulic pressure in the first hydraulic line exceeds a specified threshold value, wherein an aperture is arranged in the first hydraulic line downstream of the pressure-limiting valve, and wherein a throttle is arranged or formed in the first hydraulic line downstream of the aperture. The following method steps are provided: determining a temperature of the medium in the reservoir, determining a total volume flow rate conveyed by the hydraulic pressure source in the first hydraulic line depending on the temperature, determining a first partial volume flow rate discharged into the reservoir through the pressure-limiting valve, and determining a second partial volume flow rate through the aperture and the throttle to the device as a difference between the total volume flow rate and the first partial volume flow rate. The method provides a particularly advantageous and simple means of determining a partial volume flow rate of the liquid medium to the device, which depends only on the input variables of the temperature of the medium, the total volume flow rate conveyed and the partial volume flow rate discharged into the reservoir. Through the combination and arrangement of pressure-limiting valve, aperture and throttle, an advantageous dependence of the volume flow rate of a medium flowing through the first hydraulic line to the device on a temperature of the medium is achieved. The method according to the invention serves to model this dependence. By means of the pressure-limiting valve, the second partial volume flow rate is limited as required. If the total volume flow rate is too high, excess medium is returned directly to the reservoir as a first partial volume flow rate. The combination of a pressure-limiting valve with as constant an opening pressure as possible upstream of an aperture and a temperature-dependent back pressure from the downstream section after the aperture in the direction of the throttle results in a temperature-dependent differential pressure at the aperture and thus a temperature-dependent second partial volume flow rate to the device, so that a temperature-dependent supply of the device is achieved. Together with the throttle, the pressure-limiting valve and the aperture are therefore configured to adjust the second partial volume flow rate depending on the temperature of the medium. The temperature-dependent supply of the device works as follows, for example: the volume flow rate through the ideal aperture is independent of the viscosity of the medium and is determined solely by the geometry of the aperture, in particular its diameter. If the actual aperture is as thin-walled as possible, its behavior will correspond at least largely to that of the ideal aperture. However, the volume flow rate through the throttle depends not only on the geometry of the throttle section, but also heavily on the viscosity of the medium at the same pressure upstream of the throttle. The colder the medium, the higher the viscosity and the lower the volume flow rate through the throttle. At low temperatures, therefore, less medium flows to the device than at high temperatures. In addition, the second partial volume flow rate depends solely on the trigger pressure of the pressure-limiting valve. The advantageous effect, i.e. a temperature-and therefore viscosity-dependent medium flow, results automatically from the arrangement of the three components. The geometry of the aperture and throttle as well as the trigger pressure of the pressure-limiting valve are preferably matched to each other in such a way that a specified, temperature-dependent medium flow is supplied to the device. The diameter of the aperture is chosen particularly such that, with a hot medium, for example 100° C., a volume flow rate that is sufficiently high for cooling is supplied. At the same time, with a cold medium, for example-30° C., the throttle section allows only a small volume flow rate that is just sufficient for lubrication. The trigger pressure of the pressure-limiting valve is preferably selected to be as low as possible or minimized to such an extent that the pressure-limiting valve still functions reliably, for example to keep the energy demand of a media source as low as possible. Appropriate simulations and model calculations are performed in particular to coordinate and optimize the throttle section, aperture, and trigger pressure.

According to a preferred further development of the invention, it is provided that the difference for a plurality of temperatures and total volume flow rates is determined as a characteristic diagram empirically, by a system of equations or by a neural network. This then provides, in particular, an especially simple means of selecting an optimum operating point for the apparatus during operation, in particular of setting a sufficiently high total volume flow rate depending on the characteristic diagram in order to ensure cooling of the device at a given temperature.

It is especially preferred that the hydraulic pressure source comprises at least one pump and that the total volume flow rate is determined as the product of a volumetric efficiency dependent on the temperature, a drive rotational speed, and a stroke volume of the pump. This provides a particularly simple means of determining the total volume flow rate.

According to a preferred further development of the invention, it is provided that the plurality of total volume flow rates are specified by a plurality of drive rotational speeds. The drive rotational speed provides a particularly simple means of varying the total volume flow rate, making it an advantageous parameter.

It is especially preferred that permissible value ranges are specified for the plurality of temperatures and/or drive rotational speeds. This is particularly advantageous in ensuring that the characteristic diagram only comprises the desired values, in particular those to be expected during subsequent operation of the apparatus or the hydraulic system. For example, a permissible value range for the temperature is specified which corresponds to an expected or component-related permissible operating temperature range of the apparatus, in particular from −30° C. to +140° C. It is further preferred that a resolution, for example 1° C., and a distance between the temperature values to be considered, for example 10° C., or a plurality of temperature values to be considered are specified and that the method according to the invention is performed for all corresponding temperature values within this value range with the specified resolution. In particular, a permissible value range for the drive rotational speed is selected depending on a technically possible value range for the corresponding pump. Alternatively, a permissible value range is selected for the total volume flow rates theoretically resulting from the permissible drive rotational speeds, in particular from 0 l/min to 30 l/min. It is further preferred that a resolution, for example 0.1 l/min, and a distance between the values to be considered, for example 0.5 l/min, or a plurality of values to be considered, are specified and that the method according to the invention is performed for all values within this value range. In particular, the method is performed for all such specified or possible combinations of temperature values and drive rotational speed or total volume flow rate values.

According to a preferred further development of the invention, it is provided that the hydraulic pressure source comprises a second pump fluidly connected in parallel to the first pump, and that the total volume flow rate is determined as the sum of the respective products of volumetric efficiency, drive rotational speed and stroke volume of the respective pump. This provides a particularly simple means of determining the total volume flow rate when the hydraulic pressure source comprises more than one pump.

It is especially preferred that the first partial volume flow rate is determined depending on a change in a fill level of the reservoir. This provides a particularly simple means of determining the first partial volume flow rate. For example, the fill level is determined by a fill level sensor assigned to the reservoir.

According to a preferred further development of the invention, it is provided that a temperature of the device is determined depending on the second partial volume flow rate and an electrical or mechanical power output of the device. This provides a particularly advantageous and simple means of checking whether, at the selected or given operating point, the temperature of the device lies within a permissible operating temperature range based on the total volume flow rate and temperature, i.e., in particular, whether the device is sufficiently cooled.

The computer program product according to the invention for execution on a computer device with the features of claim 9 is characterized in that, when used as intended, it executes the method according to the invention. This results in the advantages already mentioned.

The computer device with the features of claim 10 is characterized in that it is specifically adapted to perform the method according to the invention or to execute the computer program product according to the invention. This also results in the advantages already mentioned above.

### BRIEF DESCRIPTION OF THE FIGURES

Further advantages and preferred features and combinations of features result in particular from the above description and from the claims. The invention will now be explained in more detail with reference to the drawings. For this purpose,

FIG. 1 shows a circuit diagram of an advantageous hydraulic system,

FIG. 2 shows a detailed view of the hydraulic system, and

FIG. 3 shows an advantageous method for determining at least one volume flow rate in the hydraulic system.

### DETAILED DESCRIPTION

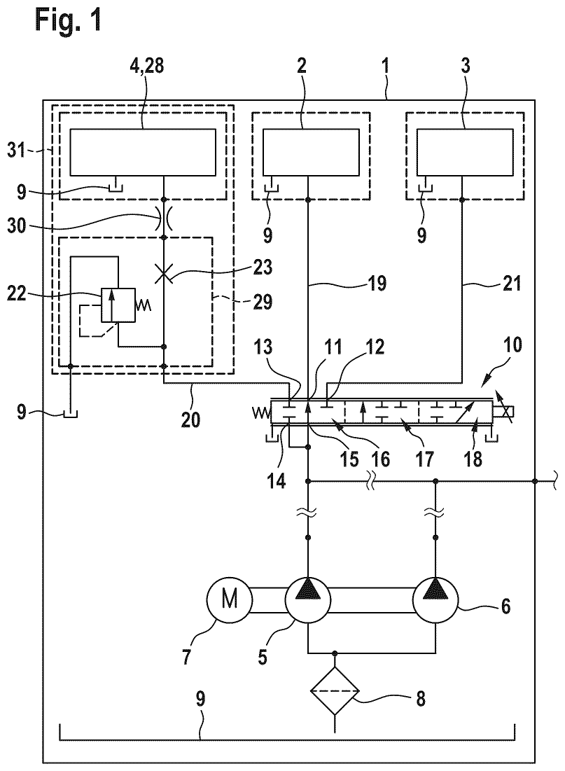

FIG. 1 shows a circuit diagram of an advantageous hydraulic system 1 configured for use in a drive module of a motor vehicle. The hydraulic system 1 comprises a first clutch 2, a second clutch 3 and a third clutch 4.

The first clutch 2 and the second clutch 3 are assigned to a first drive machine, in particular an internal combustion engine, which is not shown, and the third clutch 4 is assigned to a second drive machine 28, in particular an electric machine, in order to selectively couple these to a transmission of the motor vehicle.

The hydraulic system 1 also comprise a common hydraulic circuit for cooling and/or lubricating at least the clutches 2, 3, 4 and the second drive machine 28. The hydraulic circuit comprises a pump 5 for conveying a liquid medium. In addition, a further pump 6 is provided, which is, however, optional and is provided in the present embodiment to supply further components of the motor vehicle, which are not shown, with medium.

The two pumps 5, 6 are arranged on a common shaft which is driven by an electric motor 7. The electric motor 7 is preferably rotational speed-controlled so that the delivery rate of the pumps 5, 6 and the respective cooling medium flow depend on the rotational speed of the electric motor 7.

The two pumps 5, 6 are connected via a suction filter 8 to a tank or reservoir 9, which serves as a storage container or sump for the medium and in which the medium is preferably stored without pressure.

Furthermore, the hydraulic circuit comprises a controllable valve 10, which is interposed between the clutches 2, 3, 4 and the pump 5, for setting a cooling medium flow at least for the clutches 2, 3, 4 and the second drive machine.

The valve 10 is designed here as an electrically actuated 5/3-way valve with three outputs 11, 12, 13 and two inputs 14, 15. A first output 11 is assigned to the first clutch 2, a second output 12 to the second clutch 3, and a third output 13 to the third clutch 4. A first input 14 and a second input 15 are both assigned to the pump 5. According to an embodiment not shown, only one input is provided, which is assigned to the pump 5. The valve 10 is then designed as a 4/3-way valve.

The valve 10 thus comprises three possible switching positions 16, 17, 18. In a first switching position 16 of the valve 10, the medium flows from the second input 15 to the first output 11 through a second hydraulic line 19 only to the first clutch 2.

In a second switching position 17 of the valve 10, the medium flows from the first input 14 to the third output 13 through a first hydraulic line 20, initially to the third clutch 4 and then to the second drive machine 28. It is therefore provided that the medium flows through both the third clutch 4 and the second drive machine 28.

For this purpose, baffles and cross-sectional changes are provided, for example, to divide and guide the cooling medium flow. In particular, the third clutch 4 is initially flowed through in sections with part of the cooling medium flow, and then the second drive machine 28.

Part of the cooling medium flow is branched off, in particular, and fed only to the second drive machine 28, so that medium is supplied to the third clutch 4 and the second drive machine 28 as required.

In a third switching position 18 of the valve 10, the medium flows from the second input 15 to the second output 12 through a third hydraulic line 21 only to the second clutch 3.

After the medium has flowed through the clutches 2, 3, 4 and the second drive machine 28, it is returned to the reservoir 9, as shown in FIG. 1.

In the first hydraulic line 20, a pressure-limiting valve 22 and then an aperture 23 are arranged downstream, i.e. in the direction of the third clutch 4 and the second drive machine 28, as a module 29. Finally, a throttle 30 formed by hydraulic lines leading to the clutch 4 and the second drive machine 28 is arranged further downstream.

The pressure-limiting valve 22, the aperture 23 and the throttle 30 are components of an advantageous apparatus 31 of the hydraulic system 1 and, as such, are configured to adjust the volume flow rate of the medium to the third clutch 4 depending on a temperature of the medium, as described at the beginning. The pressure-limiting valve 22 in turn discharges excess medium into the reservoir 9 and is designed here as a seat valve.

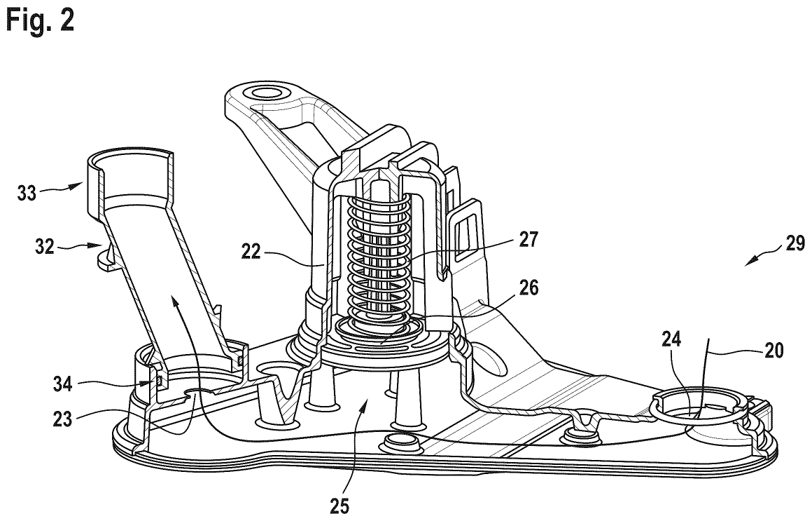

FIG. 2 shows a detailed view of the module 29 in the second flow path 20, the direction of flow of which is indicated by an arrow. The medium flows through an inlet opening 24 into an area 25. The pressure-limiting valve 22, designed as a seat valve, is located above the area 25.

A valve disc 26 of the pressure-limiting valve 22 seals off the area 25 as long as the force resulting from the pressure exerted by the medium on the valve disc 26 is less than the force exerted on the valve disc by the spring force of a spring element 27 arranged on the side of the valve disc 26 facing away from the area 25.

If the pressure exerted by the medium is greater than the pressure exerted by the spring element 27 in accordance with the spring force, the valve disc is displaced so that excess medium flows through the opening thus created into the pressure-limiting valve 22, which in turn is connected to the reservoir 9 as described above, so that the medium flows back into the reservoir 9.

Further along the second flow path 20, the aperture 23 can be seen. In the present embodiment, it has a constant flow cross-section and serves as an outlet opening for the medium from area 25.

Downstream of the aperture 23, a tubular adapter element 32 is arranged in the first hydraulic line 20 as part of the throttle 30, wherein the adapter element 32 fluidly connects the apparatus 31 to the hydraulic lines leading to the clutch 4 and the second drive machine 28.

The adapter element 32 comprises a first open end 33 with a first cross-section, which is assigned to the aperture 23, and a second open end 34 with a second cross-section, which is assigned to the hydraulic lines. In the present embodiment, the second cross-section is smaller than the first cross-section. In the present embodiment, the adapter element 32 has a continuously decreasing cross-section along its longitudinal extension, i.e. along the direction of flow, and is therefore conical in shape.

By suitably selecting the second cross-section and the geometric design of the adapter element 32, it is possible, on the one hand, to ensure that the apparatus 31 can be adapted in an advantageously simple manner to hydraulic lines with corresponding cross-sections and, on the other hand, to create an advantageous additional means of influencing a throttle section and thus the properties of the throttle 30. The throttle 30 can therefore be advantageously adapted to the cooling and/or lubrication requirements of the clutch 4 and the second drive machine 28.

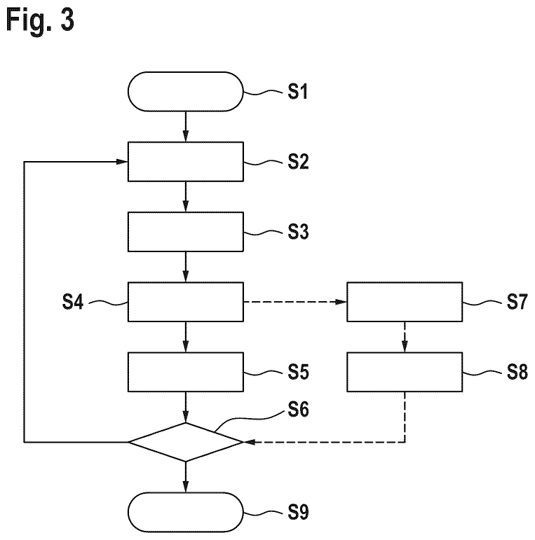

Finally, FIG. 3 shows an advantageous method for determining at least one volume flow rate in the hydraulic system 1. The method begins with a step S1. In the step S1, permissible value ranges for a temperature of the medium and for drive rotational speeds of at least one of the pumps 5, 6 and corresponding pairs of values are specified. The method steps S2 to S5 are performed for a plurality of temperatures and drive rotational speeds within the value ranges, as explained below.

In a step S2, a temperature of the medium in the reservoir 9 is first determined. Subsequently, a total volume flow rate conveyed by the pump 5, 6 in the first hydraulic line 20 is determined depending on the temperature. The total volume flow rate is determined as the product of a volumetric efficiency dependent on the temperature, a drive rotational speed and a stroke volume of the pump 5, 6. If both pumps 5, 6 are considered, the total volume flow rate is determined as the sum of the respective products.

In a step S3, a first partial volume flow rate discharged into the reservoir 9 through the pressure-limiting valve 22 is determined. This is determined depending on a change in a fill level of the reservoir 9, for example by means of a corresponding sensor.

In a step S4, a second partial volume flow rate through the aperture 23 and the throttle 30 to the device is determined as a difference between the total volume flow rate and the first partial volume flow rate. This is stored in a step S5 in a corresponding characteristic diagram.

Starting from the step S4, in an optional step S7, a temperature of the device is determined depending on the second partial volume flow rate and an electrical or mechanical power output of the device. This is stored in a step S8 in a corresponding characteristic diagram.

In a step S6 following the steps S5 and S8, it is checked whether a second partial volume flow rate has been calculated for all specified pairs of values for the temperature and the drive rotational speeds within the permissible value ranges.

If this is not the case, the method returns to the step S2, in which at least one of the parameters is changed accordingly, for example, the drive rotational speed or the temperature is increased or decreased. The first partial volume flow rate is determined in particular empirically, by a system of equations or by a neural network.

If it is determined in the step S6 that the characteristic diagram or diagrams are complete, i.e., that corresponding partial volume flow rates or temperatures are entered for all pairs of values, the method ends in step S9.

### REFERENCE LIST

1 hydraulic system
2 first clutch
3 second clutch
4 third clutch
5 pump
6 further pump
7 electric motor
8 suction filter
9 reservoir
10 valve
11 first output
12 second output
13 third output
14 first input
15 second input
16 first switching position
17 second switching position
18 third switching position
19 second hydraulic line
20 first hydraulic line
21 third hydraulic line
22 pressure-limiting valve
23 aperture
24 inlet opening
25 area
26 valve disc
27 spring element
28 second drive machine
29 module
30 throttle
31 apparatus
32 adapter element
33 first end
34 second end

1-10. (canceled)

11. A method for determining at least one volume flow rate in an apparatus for a hydraulic system, in particular of a motor vehicle, wherein the apparatus comprises a first hydraulic line which is connectable, on the one hand, to a hydraulic pressure source for conveying a liquid medium, in particular comprising at least one pump, and, on the other hand, to at least one device to be cooled and/or lubricated, wherein the first hydraulic line is assigned a pressure-limiting valve which comprises a tank connection to a reservoir for the liquid medium and connects the first hydraulic line to the tank connection when a hydraulic pressure in the first hydraulic line exceeds a specified threshold value, wherein an aperture is arranged in the first hydraulic line downstream of the pressure-limiting valve, and wherein a throttle is arranged or formed in the first hydraulic line downstream of the aperture, comprising the steps of:
determining a temperature of the medium in the reservoir,
determining a total volume flow rate conveyed by the hydraulic pressure source in the first hydraulic line depending on the temperature,
determining a first partial volume flow rate discharged into the reservoir through the pressure-limiting valve, and
determining a second partial volume flow rate through the aperture and the throttle to the device as a difference between the total volume flow rate and the first partial volume flow rate.

12. The method according to claim 11, wherein the difference is determined for a plurality of temperatures and total volume flow rates as a characteristic diagram empirically, by a system of equations or by a neural network.

13. The method according to claim 11, wherein the hydraulic pressure source comprises at least one pump and the total volume flow rate is determined as the product of a volumetric efficiency dependent on the temperature, a drive rotational speed and a stroke volume of the pump.

14. The method according to claim 12, wherein the plurality of total volume flow rates are specified by a plurality of drive rotational speeds.

15. The method according to claim 14, wherein permissible value ranges are specified for the plurality of temperatures and/or drive rotational speeds.

16. The method according to claim 13, wherein the hydraulic pressure source comprises a second pump fluidly connected in parallel to the first pump, and in that the total volume flow rate is determined as the sum of the respective products of volumetric efficiency, drive rotational speed and stroke volume of the respective pump.

17. The method according to claim 11, wherein the first partial volume flow rate is determined depending on a change in a fill level of the reservoir.

18. The method according to claim 11, wherein a temperature of the device is determined depending on the second partial volume flow rate and an electrical or mechanical power output of the device.

19. A computer program product for execution on a computer device, wherein the computer program product executes a method according to claim 11.

20. A computer device adapted to execute the computer program product according to claim 19.

21. The method according to claim 12, wherein the hydraulic pressure source comprises at least one pump and the total volume flow rate is determined as the product of a volumetric efficiency dependent on the temperature, a drive rotational speed and a stroke volume of the pump.

22. The method according to claim 13, wherein the plurality of total volume flow rates are specified by a plurality of drive rotational speeds.

23. The method according to claim 14, wherein the hydraulic pressure source comprises a second pump fluidly connected in parallel to the first pump, and in that the total volume flow rate is determined as the sum of the respective products of volumetric efficiency, drive rotational speed and stroke volume of the respective pump.

24. The method according to claim 15, wherein the hydraulic pressure source comprises a second pump fluidly connected in parallel to the first pump, and in that the total volume flow rate is determined as the sum of the respective products of volumetric efficiency, drive rotational speed and stroke volume of the respective pump.

25. The method according to claim 12, wherein the first partial volume flow rate is determined depending on a change in a fill level of the reservoir.

26. The method according to claim 13, wherein the first partial volume flow rate is determined depending on a change in a fill level of the reservoir.

27. The method according to claim 14, wherein the first partial volume flow rate is determined depending on a change in a fill level of the reservoir.

28. The method according to claim 15, wherein the first partial volume flow rate is determined depending on a change in a fill level of the reservoir.

29. The method according to claim 16, wherein the first partial volume flow rate is determined depending on a change in a fill level of the reservoir.

30. The method according to claim 11, wherein a temperature of the device is determined depending on the second partial volume flow rate and an electrical or mechanical power output of the device.
